(19) United States
(12) Patent Application Publication
(10) Pub. No.: US 2025/0023707 A1
(43) Pub. Date: Jan. 16, 2025

(54) METHOD AND DEVICE WITH HOMOMORPHIC ENCRYPTION OPERATION

(71) Applicants: SAMSUNG ELECTRONICS CO., LTD., Suwon-si (KR); Graz University of Technology, Graz (AT)

(72) Inventors: Ahmet Can MERT, Graz (AT); . AIKATA, Graz (AT); Sujoy SINHA ROY, Graz (AT); Sunmin KWON, Suwon-si (KR); Maksim DERIABIN, Suwon-si (KR)

(73) Assignees: SAMSUNG ELECTRONICS CO., LTD., Suwon-si (KR); Graz University of Technology, Graz (AT)

(21) Appl. No.: 18/768,933

(22) Filed: Jul. 10, 2024

(30) Foreign Application Priority Data
Jul. 11, 2023 (KR) 10-2023-0089969
Feb. 29, 2024 (KR) 10-2024-0029712

(51) Int. Cl. H04L 9/00

(52) U.S. Cl. CPC H04L 9/008; H04L 2209/125

(57) ABSTRACT

An operation method includes obtaining an input matrix including a coefficient of a polynomial, based on a preprocessing unit (PU), performing a preprocessing operation on the coefficient, based on a first number-theoretic transform (NTT) architecture, performing a first NTT operation on a column element of the input matrix for which the preprocessing operation is completed, performing a Hadamard product operation between a result of the first NTT operation and a twiddle factor, and based on a second NTT architecture, performing a second NTT operation on a row element of the input matrix for which the Hadamard product operation is completed.

### CROSS-REFERENCE TO RELATED APPLICATIONS

This application claims the benefit under 35 USC § 119 (a) of Korean Patent Application No. 10-2023-0089969, filed on Jul. 11, 2023, and Korean Patent Application No. 10-2024-0029712, filed on Feb. 29, 2024, in the Korean Intellectual Property Office, the entire disclosures of which are incorporated by reference herein for all purposes.

### BACKGROUND

### 1. Field

The following description relates to a number-theoretic transform (NTT) processing method and device.

### 2. Description of Related Art

Homomorphic encryption (HE) is a promising encryption method that enables arbitrary operations between encrypted data. Utilizing HE enables arbitrary operations to be performed on encrypted data without decrypting the encrypted data, while allowing the operations-transformed encrypted data to be decrypted to produce a result equivalent to what would have resulted from applying the operations to the data if it had not been encrypted. Moreover, HE is lattice-based and thus resistant to quantum algorithms.

In recent trends, chip sizes like those of central processing units (CPUs), graphics processing units (GPUs), and neural processing units (NPUs) have been growing, surpassing 800 square millimeters (mm2). This increase in size may lead to issues with increasing yield limitations in micro-processor production technology. Research aiming to implement HE accelerators using application-specific integrated circuits (ASICs) is also increasing the number of operators to enhance performance. This may lead to an increase in chip size, also resulting in decreased yield.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an operation method includes obtaining an input including a coefficient of a polynomial, performing, by a preprocessing unit (PU), a preprocessing operation on the coefficient, based on a first number-theoretic transform (NTT) architecture, performing a first NTT operation on a first element of the input for which the preprocessing operation is completed, performing a Hadamard product operation between a result of the first NTT operation and a twiddle factor, and based on a second NTT architecture, performing a second NTT operation on a second element of the input for which the Hadamard product operation is completed.

The first NTT architecture may include a first NTT unit corresponding to a stage included in the first NTT operation, and first NTT units included in the first NTT architecture may be operated independently of each other.

Each of the first NTT units may include a butterfly operation unit (BU), a register, a first multiplexer, and a second multiplexer.

The performing of the preprocessing operation may include multiplying the coefficient by a 2N-th root of unity, and the N may be a size of the input.

The performing of the second NTT operation may include log 2N*(N/2) second NTT units, and the N may be a size of the input matrix.

The PU may include a modular multiplier.

The performing of the Hadamard product operation may include, based on a modular multiplier, performing the Hadamard product operation.

The input may be a matrix, and the first element may be a column of the matrix.

The second element may be a row of the matrix.

In another general aspect, an operation device includes a PU configured to perform a preprocessing operation on coefficients of a polynomial, wherein an input matrix includes the coefficients of the polynomial, a first NTT architecture configured to perform a first NTT operation on a column element of the input matrix for which the preprocessing operation is completed, a Hadamard unit configured to perform a Hadamard product operation between a result of the first NTT operation and a twiddle factor, and a second NTT architecture configured to perform a second NTT operation on a row element of the input matrix for which the Hadamard product operation is completed.

The first NTT architecture may include a first NTT unit corresponding to a stage included in the first NTT operation, and first NTT units included in the first NTT architecture may be operated independently of each other.

Each of the first NTT units may include a BU, a register, a first multiplexer, and a second multiplexer.

The PU may be configured to perform an operation of multiplying the coefficient by a 2N-th root of unity, and the N may be a size of the input matrix.

The second NTT architecture may include log 2N*(N/2) second NTT units, and the N may be a size of the input matrix.

The PU may include a modular multiplier.

The Hadamard unit may be configured to, based on a modular multiplier, perform the Hadamard product operation.

The second NTT architecture may be configured to perform a first inverse NTT (INTT) operation on a row element of an INTT matrix, the Hadamard unit may be configured to perform an INTT Hadamard product operation between a result of the first INTT operation and the twiddle factor, the first NTT architecture may be configured to perform a second INTT operation on a column element of the INTT matrix for which the INTT Hadamard product operation is completed, and the modular multiplier may be configured to perform a postprocessing operation on a result of the second INTT operation.

The operation may further include PUs, including the PU, which may be interconnected to form a ring topology, and each PU may be configured with a respective memory chiplet that is not connected to the other Pus.

In another general aspect, a computing apparatus is configured for performing homomorphic encryption (HE) operations, and the computing apparatus includes: core chiplets interconnected with each other to form a ring topology, each core chiplet configured to perform a respective number-theoretic transform (NTT), wherein each core chiplet is connected to a corresponding memory chiplet that is not connected the other core chiplets; and the core chiplets are configured to perform an HE operation on an input matrix inputted to the computing apparatus, the input matrix comprising coefficients of a polynomial to be subjected to the HE operation.

Other features and aspects will be apparent from the following detailed description, the drawings, and the claims.

### BRIEF DESCRIPTION OF THE DRAWINGS

FIG. 1 illustrates an example of a homomorphic encryption (HE) system, according to one or more embodiments.

FIG. 2 illustrates an example of a 2.5 dimensional (2.5D) chiplet-based accelerator, according to one or more embodiments.

FIG. 3 illustrates an example of a 3D chiplet-based accelerator, according to one or more embodiments.

FIG. 4 illustrates an example of a core chiplet, according to one or more embodiments.

FIG. 5 illustrates an example of a parallel processing function of a core chiplet, according to one or more embodiments.

FIGS. 6A and 6B illustrate examples of a number-theoretic transform (NTT) operation method, according to one or more embodiments.

FIG. 7 illustrates an example of an NTT operation method, according to one or more embodiments.

FIG. 8 illustrates an example of an operation of a first NTT architecture, according to one or more embodiments.

FIG. 9 illustrates an example of an operation of a second NTT architecture, according to one or more embodiments.

FIG. 10 illustrates an example of a data exchange method among chiplets, according to one or more embodiments.

FIGS. 11A to 11C illustrate examples of a chiplet architecture, according to one or more embodiments.

Throughout the drawings and the detailed description, unless otherwise described or provided, it may be understood that the same or like drawing reference numerals refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

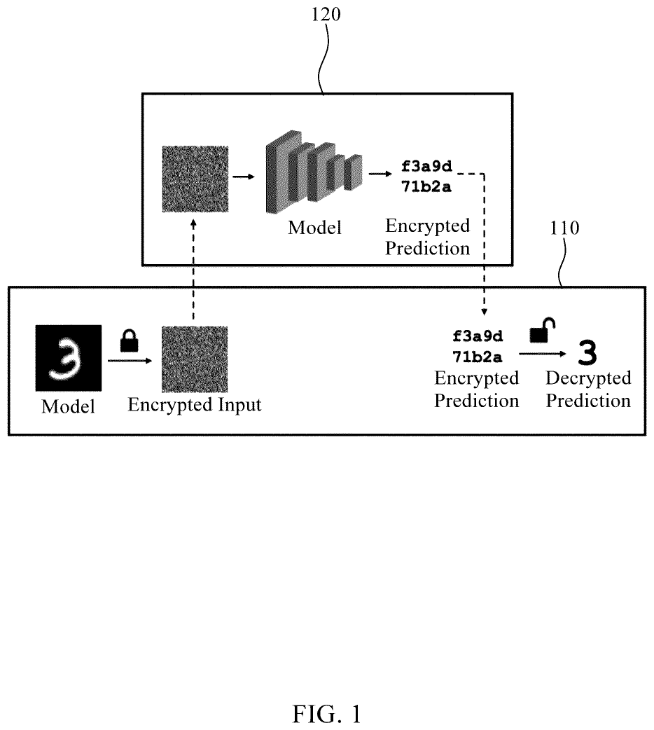

FIG. 1 illustrates an example of a homomorphic encryption (HE) system, according to one or more embodiments.

Referring to FIG. 1, the HE system may include a client 110 and a server 120 as agents.

The server 120 may provide an artificial intelligence service to the client 110 without directly exposing data of the client 110 to the server 120; the data is not exposed because the client 110 homomorphically encrypts the data before sending the data to the server 120.

The client 110 is an agent accessing the artificial intelligence service of the server 120 and may be referred to as a service using entity, a service user, a data user, a user device, and the like. The client 110 may encrypt its own data (e.g., an image) (e.g., as a function of a client terminal) based on an HE encryption scheme and transmit the encrypted data to the server 120. The client terminal may be referred to as a user terminal.

An HE scheme is for performing operations on encrypted data without requiring decryption of the data to perform the operation. In other words, operations may be performed directly on homomorphically encrypted data to transform the homomorphically encrypted data. After such operations are performed on the homomorphically encrypted data (encrypted from cleartext), when the operations-transformed results are decrypted, the decrypted result is identical to what would have resulted if those same operations had been performed on the cleartext (the data if it had not been in encrypted form). Because a HE scheme allows processing data while the data is encrypted, it provides a solution to privacy concerns in the data industry.

The server 120 may receive the homomorphically encrypted data from the client 110 and transmit a result of performing an artificial intelligence operation on the encrypted data to the client 110. The server 120 may be referred to as a service provider, a service providing entity, and the like.

The server 120 may provide various artificial intelligence services to the client 110. For example, the server 120 may provide the client 110 with a service such as face recognition or mask detection, where maintaining the confidentiality of user data is desirable. However, an operation required for providing an artificial intelligence service requires a large amount of memory and extensive network data transmission. For example, when encrypting data that is to be subjected to an inference operation by a convolutional neural network (CNN), numerous homomorphic ciphertexts are generated, demanding a large amount of memory and extensive network data transmission. In other words, homomorphically encrypted data can be significantly larger than its corresponding cleartext.

An HE operation may support an addition operation, a multiplication operation, and a rotation operation, which rearranges the order within the same encryption, and the execution time increases in the order of addition, multiplication, and rotation.

A homomorphic encryption scheme may have a predetermined degree of a polynomial as a parameter. This degree may be a power of 2. As the degree of a polynomial increases, the execution time of operations exponentially increases. However, a higher degree of a polynomial enables a wider variety of operations and improves the accuracy of calculations.

An HE operation may allow a predetermined maximum number of HE multiplications. As this maximum number of multiplications increases, the time required for a single HE operation increases exponentially. Furthermore, this maximum number of multiplications is limited by the degree of a polynomial. As the degree increases, the maximum number of multiplications also increases.

HE operations may require 1000 times more performance and memory capacity than plaintext in terms of complexity and memory usage. Accordingly, when the HE operation is performed on a central processing unit (CPU), the execution time of the operation may be so slow that the operation may not be used in an actual application. Thus, a technique for accelerating an HE operation using a graphics processing unit (GPU), a field-programmable gate array (FPGA), and the like is proposed.

A monolithic accelerator architecture for a lattice-based HE operation may be significantly expensive and may require complex manufacturing processes. In addition, a large monolithic architecture may face a persistent issue of low yield. As an alternative, a multi-chiplet architecture according to an example may be used to accelerate an HE operation. Using a multi-chiplet design instead of one large chip may reduce manufacturing costs and increase yields. Furthermore, when the multi-chiplet architecture is used, multiple configurations are possible, providing flexibility to a single tape-out.

A chiplet architecture may include processing elements (PEs) and a memory. The PEs may communicate with one another and may communicate with an external memory (e.g., high bandwidth memory (HBM)). A scalable design methodology that may be utilized to provide exceptional acceleration with a chiplet-based accelerator is described herein.

“Chiplet” refers to breaking apart a chip into two or more parts instead of integrating components into a single die. A chiplet system may offer efficiency due to less expensive manufacturing requirements and high yield and may provide flexibility with various configurations through a single tape-out. To elaborate, a chiplet is not a package type, but rather is configured to be a part of a packaging architecture. A chiplet is generally an integrated circuit block (a chip) that has been specifically designed to communicate with other chiplets, to form larger more complex integrated circuits (ICs). Large and complex chip designs may be subdivided into functional circuit blocks (often reusable) using chiplets. Chiplets are manufactured as distinct chips and then recombined on, for example, a high density interconnect to form a larger IC/architecture.

Chiplet packaging may be classified into three broad categories of 2 dimensional (2D) packaging, 2.5D packaging, and 3D packaging. In 2D packaging, various dies, known as multi-chip modules (MCMs), are mounted on a substrate. 2D packaging is named as such because all dies are placed on the same plane. Due to substrate limitations, 2D packaging may lead to slow communication between dies and high power consumption.

In 2.5D packaging, an interposer is disposed between a die and a substrate, and a die-to-die connection may be established via the interposer. The high interconnectivity provided by the interposer may improve performance. 3D packaging refers to stacking different dies, similar to how skyscrapers are constructed, taking packaging to the next level of advancement. Dies in 3D packaging may be connected to one another through a through-silicon via (TSV). As an example, there is HBM, which includes multiple stacked HBM dynamic random access memory (DRAM) dies. 3D packaging may shorten a critical path, providing significantly higher performance, lower power consumption, and higher bandwidth than 2.5D packaging?.

Another advantage of the multi-chiplet architecture according to an example is the potential for heterogeneous packaging. This allows an existing chiplet to be reused and various chiplets to be integrated depending on their functions. However, chiplet placement is a lengthy and intricate process. Incorrect placement may lead to potential deadlock issues in chiplet-to-chiplet communication, even if such issues do not exist at the design level.

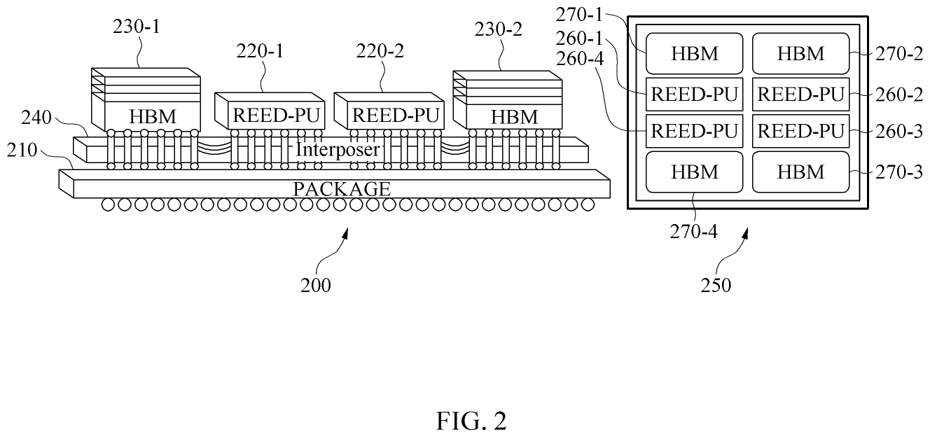

FIG. 2 illustrates an example of a 2.5D chiplet-based accelerator, according to one or more embodiments.

FIG. 2 illustrates a front/side view of a 2.5D chiplet-based accelerator 200 and a plan/top view of a 2.5D chiplet-based accelerator 250. The 2.5D chiplet-based accelerator 200 may connect two PEs (a first core chiplet 220-1 and a second core chiplet 220-2) together and may connect two memories (a first memory chiplet 230-1 and a second memory chiplet 230-2) together through an interposer 240. However, the internal structure of the 2.5D chiplet-based accelerator 200 is not limited to the illustration shown in FIG. 2. It is to be understood by one of ordinary skill in the art to which the disclosure pertains that some of the components shown in FIG. 2 may be omitted or new components may be added according to the design of the 2.5D chiplet-based accelerator 200.

Neighboring core chiplets may be connected to each other through the interposer 240. The interposer 240 may be attached to the top of a substrate 210 and may include multiple interposer through-electrodes.

A core chiplet may be referred to as a PE or a PU, and REED (or REED-PU). Furthermore, a memory of the 2.5D chiplet-based accelerator 200 may also be implemented in the form of a chiplet. In this case, a memory chiplet may include an HBM chiplet. The memory chiplet may be referred to as an external memory to distinguish the memory chiplet from a register in a core chiplet.

It may be difficult for chiplet packaging to have complex connectivity due to the nature of an interposer. Therefore, with embodiments of a multi-chiplet architecture described herein, it may be beneficial for PEs not to share memory chiplets, and a connection between PEs may be simple rather than complex. For example, the first core chiplet 220-1 and the second core chiplet 220-2 may not share memory chiplets. In other words, the first memory chiplet 230-1 may be connected to the first core chiplet 220-1 but not to the second core chiplet 220-2. Similarly, the second memory chiplet 230-2 may be connected to the second core chiplet 220-2 but not to the first core chiplet 220-1.

Furthermore, a 2.5D chiplet-based accelerator 250 may connect four PEs (a first core chiplet 260-1 to a fourth core chiplet 260-4) together and connect four memories (a first memory chiplet 270-1, a second memory chiplet 270-2, a third memory chiplet 270-3, and a fourth memory chiplet 270-4) together through an interposer.

In this case, the first core chiplet 260-1 to the fourth core chiplet 260-4 are in a ring structure, and thus, neighboring core chiplets may be connected to each other through the interposer 240. The first core chiplet 260-1, the second core chiplet 260-2, the third core chiplet 260-3, and the fourth core chiplet 260-4 may be connected to one another in the listed order in a ring structure. In other words, the connection between the first core chiplet 260-1 and the third core chiplet 260-3 is established only through the second core chiplet 260-2, and a direct connection between the first core chiplet 260-1 and the third core chiplet 260-3 may not be established. The same may also apply between the second core chiplet 260-2 and the fourth core chiplet 260-4. Put another way, first core chiplet 260-1 may be connected only to its ring neighbors (second and fourth core chiplets 260-2 and 260-4), second core chiplet 260-2 may be connected only to its ring neighbors (first and third core chiplets 260-1 and 260-3), and third core chiplet 260-3 may be only connect to its ring neighbors (second and fourth core chiplets 260-2 and 260-4), and so forth. Here, “connected only to” refers to connections to ring core chiplets and does not preclude connections to other components such as I/O interfaces and memory chiplets, for example.

Likewise, in the 2.5D chiplet-based accelerator 250, the first core chiplet 260-1 to the fourth core chiplet 260-4 may not directly share memory chiplets between themselves. For example, the first memory chiplet 270-1 may be connected to the first core chiplet 260-1 but not to the other core chiplets (260-2, 260-3, and 260-4). The second memory chiplet 270-2 may be connected to the second core chiplet 260-2 but not to the other core chiplets (260-1, 260-3, and 260-4). The third memory chiplet 270-3 may be connected to the third core chiplet 260-3 but not to the other core chiplets (260-1, 260-2, and 260-4). The fourth memory chiplet 270-4 may be connected to the fourth core chiplet 260-4 but not to the other core chiplets (260-1, 260-2, and 260-3). A technique for designing a 2.5D chiplet-based accelerator is not limited to the technique described above. Depending on the design, the number of core chiplets and memory chiplets may vary.

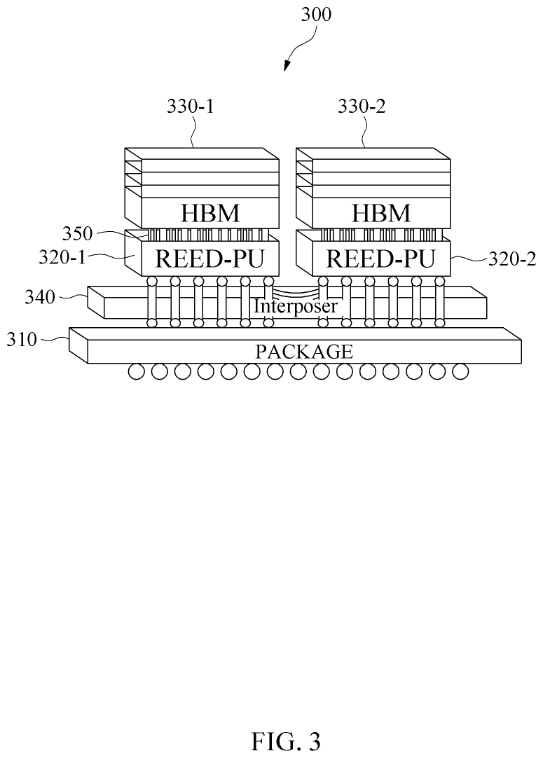

FIG. 3 illustrates an example of a 3D chiplet-based accelerator, according to one or more embodiments.

Referring to FIG. 3. a 3D chiplet-based accelerator 300 may connect two PEs (a first core chiplet 320-1 and a second core chiplet 320-2) together and connect two memories (a first memory chiplet 330-1 and a second memory chiplet 330-2) to the top of the PEs (the first core chiplet 320-1 and the second core chiplet 320-2) through a TSV 350. However, the internal structure of the 3D chiplet-based accelerator 300 is not limited to the illustration shown in FIG. 3. It is to be understood by one of ordinary skill in the art to which the disclosure pertains that some of the components shown in FIG. 3 may be omitted or new components may be added according to the design of the 3D chiplet-based accelerator 300.

Neighboring core chiplets (the first core chiplet 320-1 and the second core chiplet 320-2) may be connected to each other through an interposer 340. The interposer 340 may be attached to the top of a substrate 310 and may include a plurality of interposer through-electrodes.

Two memories (the first memory chiplet 330-1 and the second memory chiplet 330-2) may be stacked on the respective PEs (the first core chiplet 320-1 and the second core chiplet 320-2). For example, the first memory chiplet 330-1 may be stacked on the first core chiplet 320-1 through the TSV 350 and the second memory chiplet 330-2 may be stacked on the second core chiplet 320-2 through the TSV 350. Accordingly, the PEs (the first core chiplet 320-1 and the second core chiplet 320-2) may not share memories (the first memory chiplet 330-1 and the second memory chiplet 330-2).

When 3D packaging is used, less chip surface area may be needed as compared to a 2.5D packaging of the shame number of chiplets. Therefore, with 3D packaging, a much smaller interposer and substrate may also be used. A technique for designing a 3D chiplet-based accelerator is not limited to the technique described above. Depending on the design, the number of core chiplets and memory chiplets may vary.

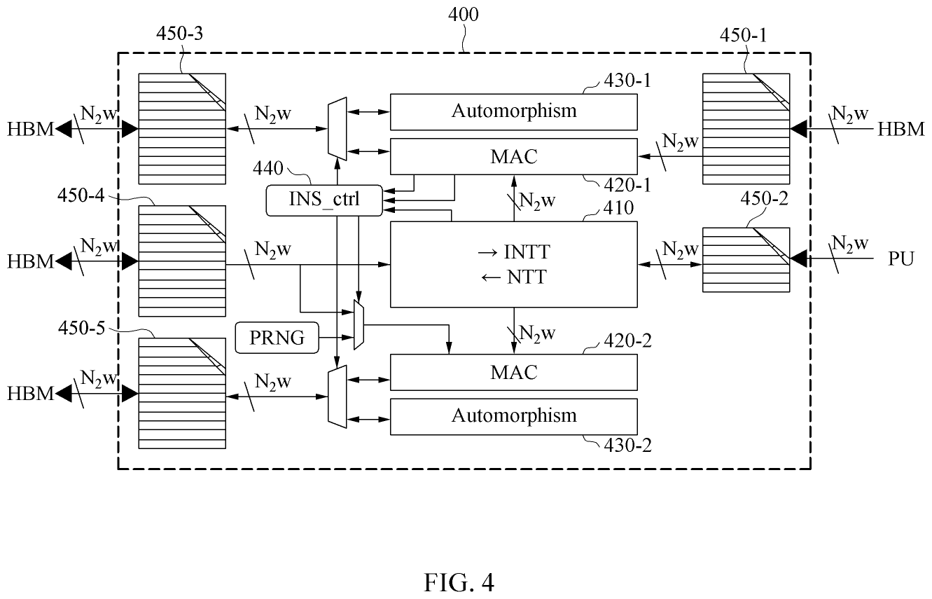

FIG. 4 illustrates an example of a core chiplet, according to one or more embodiments. The description provided with reference to FIGS. 1 to 3 may generally apply to FIG. 4.

Referring to FIG. 4, a core chiplet 400 may be used as an accelerator component. The core chiplet 400 may also be referred to as a HE processing core chiplet. As described above, the accelerator may be an accelerator for an HE operation. A hardware architecture that includes the core chiplet 400 may be configured based on a parameter of N=N1*N2, where N, N1, and N2 are powers of 2, and N is the size of a polynomial. In an architecture with the N1*N2 configuration, individual arithmetic units may require a memory bandwidth of N2 coefficients per cycle and may provide f/N1 operational throughput per second (f denotes a design operating frequency).

Since memory bandwidth is a major bottleneck in an HE operation, a configuration/architecture according to one or more embodiments may readily scale within this constraint, providing optimal throughput. Some embodiments may provide easy configuration of N1 and N2 values based on available resources and throughput requirements and may also facilitate prototyping and verification. Since all configurations generally follow the same design and implementation strategy, verifying the functionality of a smaller configuration may also provide proof of the workability of a much larger configuration. Thus, formal verification of the entire design may be simpler.

An HE operation may include basic operations such as an addition operation, a multiplication operation, and a rotation operation. High level operations of most applications, such as machine learning and statistics, may be performed using these atomic operations (sometimes, in complex combinations). In HE, noise may be randomly added to a ciphertext for security purposes. The noise of the ciphertext increases as more operations are performed on the ciphertext (transforming the ciphertext). A bootstrapping operation may be used to reduce the noise. The bootstrapping operation may make a homomorphic encryption schema “fully HE (FHE)”. Some examples of accelerators described herein may include all components sufficient to implement an FHE system.

The core chiplet 400 may be a basic component for HE processing using a residue number system (RNS). The core chiplet 400 may be designed with efficient routing and placement strategy in mind. In particular, since a relinearization operation is the most expensive operation, the core chiplet 400 may be tailored to ensure high throughput for the same.

After being subjected to a multiplication, a nonlinear ciphertext component may include L polynomials (1 for each qᵢ RNS base, i≤L). For relinearization of the ciphertext, all L residue polynomials may be converted from slots into coefficient representations (using an inverse number theoretic transform (INTT)), each polynomial may be converted into (L+K) NTT, and then multiply and accumulate may be performed on two key components. K denotes the number of pi RNS bases required for key switching. This part may require multiplication and accumulation of L INTTs, L*(L+K) NTT, and 2L*(L+K). This operational throughput may be reduced through an f/(L*(1+3 (L+K))*N1) operation.

The core chiplet 400 may include an NTT module 410. The core chiplet 400 may further include a first multiply-accumulate (MAC) module 420-1, a second MAC module 420-2, a first automorphism module 430-1, a second automorphism module 430-2, a controller 440, a first register 450-1, a second register 450-2, a third register 450-3, a fourth register 450-4, and a fifth register 450-5.

The NTT module 410 may perform an NTT operation and an INTT operation. The NTT module 410 may be referred to as an NTT/INTT module. The NTT module 410 may be configured to work with one polynomial at a time, however, the results may be accumulated by multiplying two polynomials (key switching keys). Thus, the core chiplet 400 may maintain the throughput of the NTT module 410 by instantiating a pair of MAC units (the first MAC module 420-1 and the second MAC module 420-2) and simultaneously processing two key components of a ciphertext.

Similarly, the core chiplet 400 may include two automorphism modules (the first automorphism module 430-1 and the second automorphism module 430-2). The first automorphism module 430-1 and the second automorphism module 430-2 may not need to operate simultaneously. Thus, the core chiplet 400 may use the same memory to supply data to both of the automorphism modules.

The core chiplet 400 may use a pseudo random number generator (PRNG) to generate a first key component. A second component may be stored in the first register 450-1 and may only be supplied to only the first MAC module 420-1. When performing a dyadic operation, the first MAC module 420-1 may receive two inputs from the first register 450-1 and the third register 450-3. However, in order to provide the same function to the second MAC module 420-2, a memory for an NTT/INTT unit may be connected.

This core chiplet design is an instruction-based design, in which the controller 440 may manage multiplexers and collect a signal completed from one of the NTT module 410, MAC modules, and automorphism modules. This configuration may ensure that the NTT module 410, MAC modules, and automorphism modules are executed in parallel in a pipeline.

The first register 450-1, the third register 450-3, the fourth register 450-4, and the fifth register 450-5 included in the core chiplet 400 may communicate with an off-chiplet memory (e.g., HBM). The second register 450-2 may communicate with another core chiplet 400 (e.g., another PU chiplet). The second register 450-2 may perform a role of storing an INTT result and transferring the INTT result to the other PU chiplet.

Of the four memories that communicate with the off-chip memory (i.e., the first register 450-1, the third register 450-3, the fourth register 450-4, and the fifth register 450-5), there may be two memories (the third register 450-3 and the fifth register 450-5) that may need to rewrite a result.

In other words, there are three memories that may be used for reading/writing on-chip and off-chip communication. The second register 450-2 may be used for an on-chip operation, and the third register 450-3 and the fifth register 450-5 may perform (or receive) prefetching with the off-chip memory. Therefore, these three memories may require at least two polynomial storages, while the other two may only require at least one polynomial storage. These memories may be readily placed at locations away from a building block and the vicinity of a chip/chiplet to avoid congestion. Then, a register file may be used to connect these memories to the building block. Accordingly, a relatively simple and high-throughput configuration may be possible.

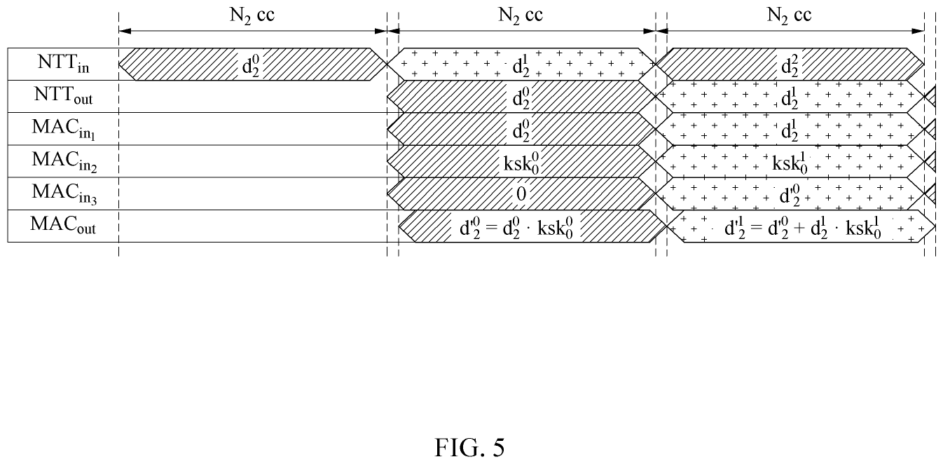

FIG. 5 illustrates an example of a parallel processing function of a core chiplet, according to one or more embodiments.

Referring to FIG. 5, the core chiplet 400 may simultaneously perform multiplication and accumulation operations. As described above, since (i) the controller 440 may manage multiplexers and (ii) may collect a signal completed from one of the NTT module 410, MAC modules, and automorphism modules, the core chiplet 400 may simultaneously perform multiplication and accumulation operations. Thus, given L polynomials, the core chiplet 400 may save 2L(L+1) clock cycles through a parallel operation and may improve throughput to

$$\frac{f}{L ( L + 3 ) \cdot {N}_{1}} ,$$

resulting in a 66.7% increase in throughput.

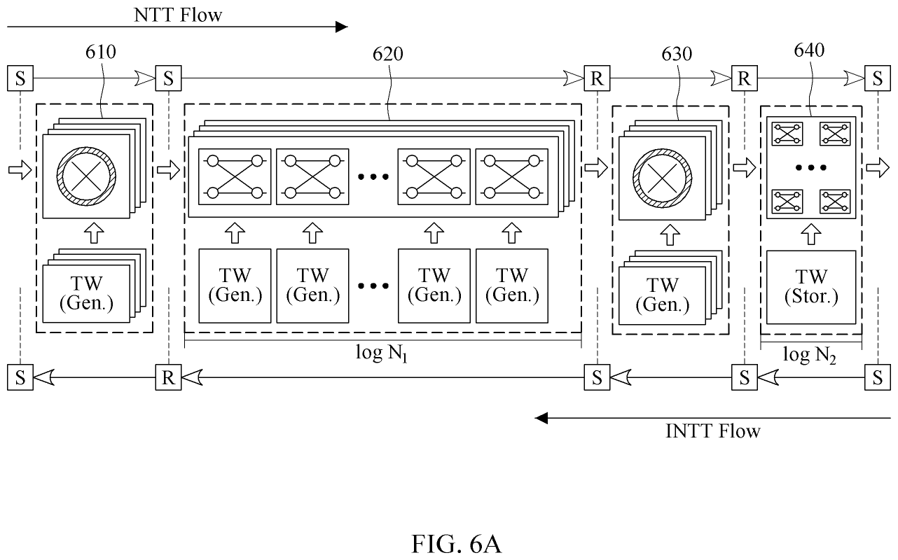

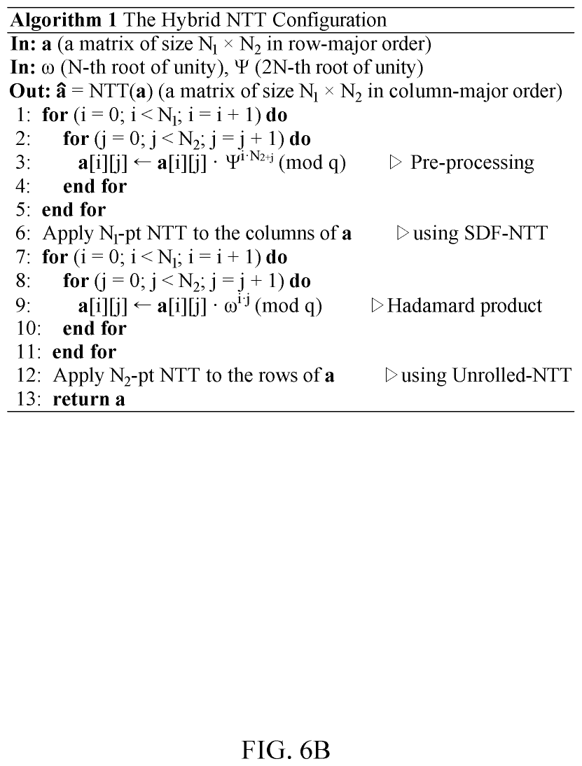

FIGS. 6A and 6B illustrate examples of an NTT operation method, according to one or more embodiments.

Referring to FIG. 6A, an NTT module (e.g., the NTT module 410 of FIG. 4) may include a preprocessing module 610, a first NTT architecture 620, a Hadamard unit 630, and a second NTT architecture 640.

The NTT module may perform an NTT operation and an INTT operation. The NTT module may perform the NTT operation by sequentially inputting an input polynomial for the NTT operation into the preprocessing module 610 (the “TW” shown as another input to the preprocessing module 610 refers to a twiddle factor, discussed later), the first NTT architecture 620, the Hadamard unit 630, and the second NTT architecture 640. The NTT module may perform the INTT operation by sequentially inputting an input polynomial for the INTT operation into the second NTT architecture 640, the Hadamard unit 630, the first NTT architecture 620, and the preprocessing module 610.

Referring to FIG. 6B, the input polynomial (“a” in Algorithm 1) for the NTT operation may be stored in the N₂ memory with a depth of N₁. Thus, an input matrix of size N₁×N₂=N may be formed in row-major order. In other words, the input matrix may hold coefficients of the input polynomial.

The preprocessing module 610 may perform a preprocessing operation on the coefficients. The preprocessing module 610 is a preprocessing operation and may perform an operation of multiplying a coefficient by a 2N-th root of unity. The preprocessing module 610 may perform a preprocessing operation such as that expressed by Equation 1.

$$a [ i ] [ j ] ← a [ i ] [ j ] \cdot {ψ}^{i \cdot {N}_{2} + j} ( mod q ) \qquad Equation 1$$

The preprocessing module 610 may be N₂-type modular multipliers.

The first NTT architecture 620 may perform a first NTT operation on a column element of an input matrix when the preprocessing operation has been completed for the input matrix. Performing the first NTT operation on the column element may be referred to as an N₁-point NTT operation. The first NTT architecture 620 may be referred to as a single delayed feedback (SDF)-NTT architecture.

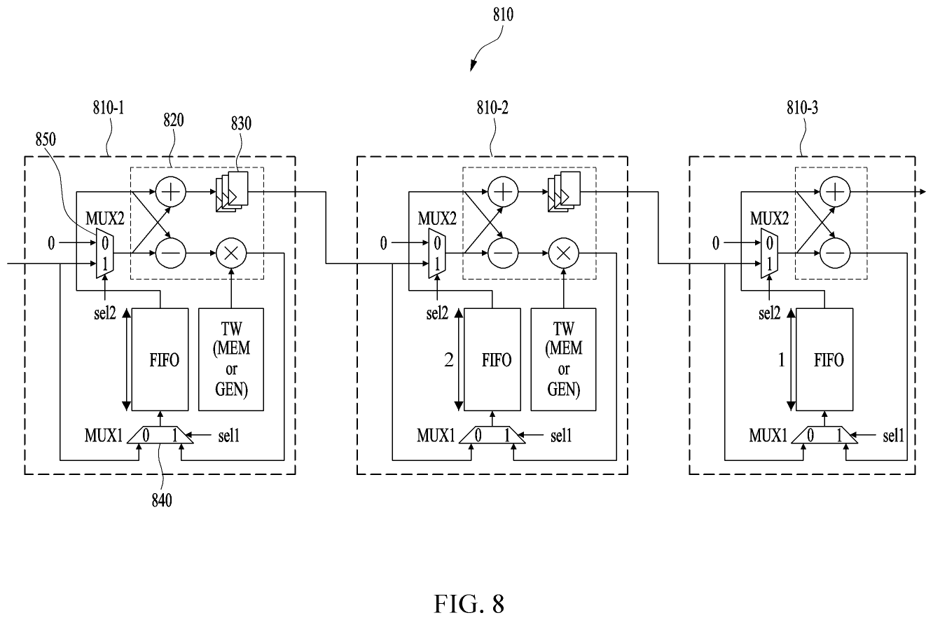

The first NTT architecture 620 may be pipelined and may read an N₂ coefficient from a memory in each cycle. The first NTT architecture 620 may include first NTT units corresponding to a stage included in the first NTT operation. The first NTT units included in the first NTT architecture 620 may be operated independently of each other. An operating method of the first NTT architecture 620 is described below with reference to FIG. 8.

The Hadamard unit 630 may perform a Hadamard product operation between a first NTT operation result and a twiddle factor. The Hadamard unit 630 may be an N₂-type modular multiplier.

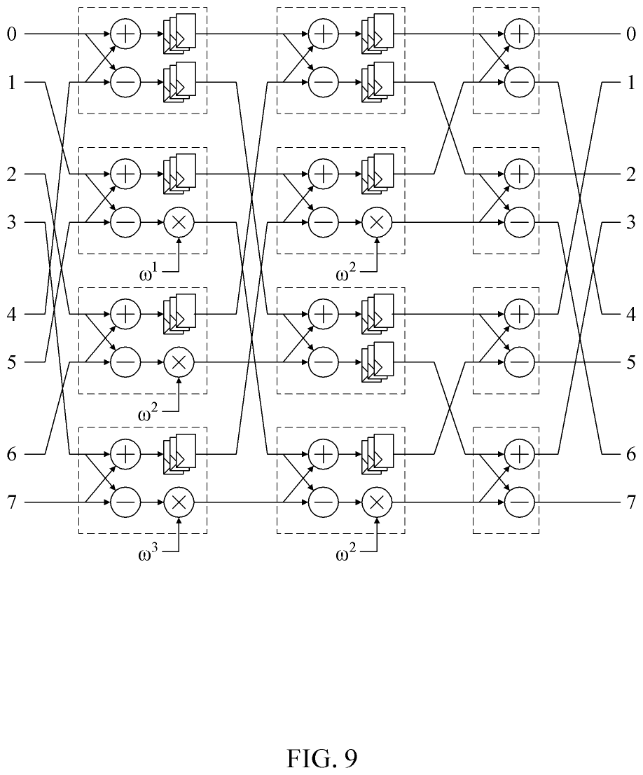

The second NTT architecture 640 may perform a second NTT operation on a row element of an input matrix for which the Hadamard product operation has been completed. Performing the second NTT operation on the row element may be referred to as an N₂-point NTT operation. The second NTT architecture 640 may be referred to as an unrolled-NTT. An operating method of the second NTT architecture 640 is described in detail below with reference to FIG. 9.

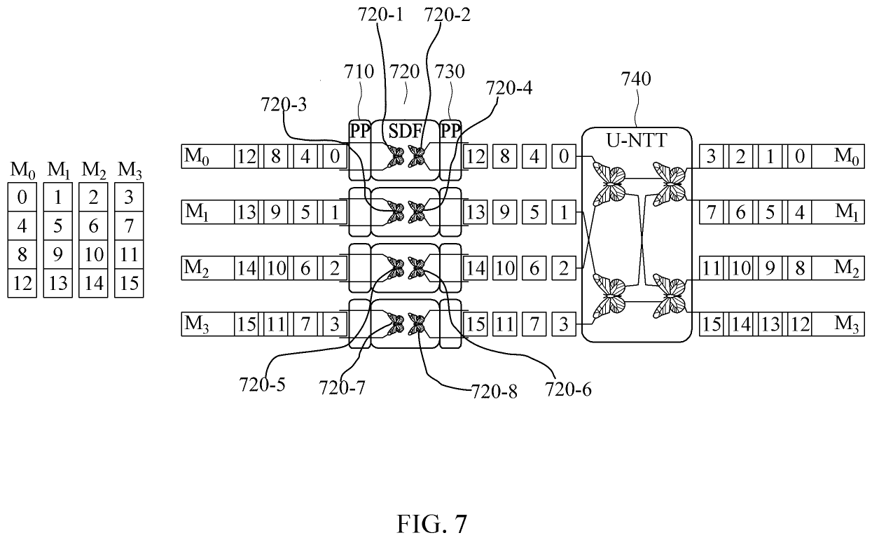

FIG. 7 illustrates an example of an NTT operation method, according to one or more embodiments.

Referring to FIG. 7, an input polynomial for an NTT operation may form an input matrix with a size of 4×4=16, as a non-limiting example. A preprocessing module 710 may perform a preprocessing operation on column elements (e.g., M₀, M₁, M₂, and M₃) of the input matrix. The preprocessing module 710 may perform a preprocessing operation on each of the column elements (e.g., M₀, M₁, M₂, and M₃) of the input matrix simultaneously (in parallel). In FIG. 7, the numbers of matrix elements represent the coefficient indices of a polynomial.

A first NTT architecture 720 (e.g., first NTT architecture 620) may include first NTT operation units that perform an NTT operation on each of the column elements (e.g., M₀, M₁, M₂, and M₃) of the input matrix, respectively. For example, first NTT operation units 720-1 and 720-2 may perform an NTT operation on the M₀ column element, first NTT operation units 720-3 and 720-4 may perform an NTT operation on the M₁ column element, first NTT operation units 720-5 and 720-6 may perform an NTT operation on the M₂ column element, and first NTT operation units 720-7 and 720-8 may perform an NTT operation on the M₃ column element.

Alternatively, the first NTT architecture 720 may include only one set of first NTT operation units. For example, the first NTT operation units 720-1 and 720-2 may perform the NTT operation on the M₀ column element in a first cycle, perform the NTT operation on the M₁ column element in a second cycle, perform the NTT operation on the M₂ column element in a third cycle, and perform the NTT operation on the M₃ column element in a fourth cycle.

The number of first NTT operation units included in the first NTT architecture 720 may be determined based on stages included in a first NTT operation. Referring to FIG. 7, since there are four coefficients of a column element of an input matrix, the first NTT operation may include two stages. Therefore, the number of first NTT operation units of the first NTT architecture 720 may be two (e.g., the first NTT operation units 720-1 and 720-2). In this case, the first NTT units (e.g., the first NTT operation units 720-1 and 720-2) included in the first NTT architecture 720 may be operated independently of each other. In other words, while the first NTT operation unit 720-2 performs an operation, the first NTT operation unit 720-1 may also perform an operation. That is, continuous operations may be performed on data input. While an operation is being performed on a previous input in the second half of a stage, it may be possible to simultaneously perform an operation on a new input in the first half of the stage.

The Hadamard unit 730 may perform a Hadamard product operation between a first NTT operation result and a twiddle factor (see the “TW”s under the first NTT architecture in FIG. 7).

The second NTT architecture 740 may perform a second NTT operation on a row element of an input matrix for which the Hadamard product operation has been completed. For example, a second NTT operation may be performed on first row elements (0, 1, 2, and 3) in the first cycle, the second NTT operation may be performed on second row elements (4, 5, 6, and 7) in the second cycle, the second NTT operation may be performed on third row elements (8, 9, 10, and 11) in the third cycle, and the second NTT operation may be performed on fourth row elements (12, 13, 14, and 15) in the fourth cycle.

The second NTT architecture 740 may include second NTT units. The number of stages to be provided for performing an NTT operation on N pieces of data may be n=log₂N. The number of second NTT units to be provided for each stage may be N/2. Accordingly, the second NTT operation may include two stages, and the number of second NTT units required for each stage may be two. Accordingly, the second NTT architecture 740 may include two second NTT units 740-1 and 740-2 required for a first stage operation and two second NTT units 740-3 and 740-4 required for a second stage operation.

An output of the first NTT architecture 720 may be directly supplied to the second NTT architecture 740. Thus, a transpose operation between the first NTT architecture 720 and the second NTT architecture 740 may not be required.

FIG. 8 illustrates an example of an operation of a first NTT architecture, according to one or more embodiments.

Referring to FIG. 8, a first NTT architecture 810 may include first NTT units (e.g., a first NTT unit 810-1, a second NTT unit 810-2, and a third NTT unit 810-3).

As described above, the first NTT units (e.g., 810-1 to 810-3) may respectively correspond to stages of a first NTT operation. For example, when an NTT operation is performed on 8 pieces of data, the number of stages required may be 3 (from log₂8). The first NTT unit 810-1 may correspond to a first stage, the second NTT unit 810-2 may correspond to a second stage, and the third NTT unit 810-3 may correspond to a third stage. The first NTT units (e.g., 810-1 to 810-3) may be operated independently of each other.

The first NTT unit 810-1 may include a butterfly operation unit (BU), a register, a first multiplexer, and a second multiplexer. For example, the first NTT unit 810-1 may include a BU 820, a register 830, a first multiplexer 840, and a second multiplexer 850.

In the first NTT unit 810-1, a butterfly operation may require two coefficients, and the indices of the coefficients may be distinguished by an offset depending on the NTT stage. For example, at a first NTT stage of an 8-point NTT for polynomial A, coefficient indices may be distinguished by an offset of 4 (i.e., for i=0, 1, 2, and 3, the coefficient indices are distinguished as A[i] and A[i+4]). At a second NTT stage, the coefficients may be grouped into upper and lower parts (i.e., A[0], A[1], A[2], A[3] and A[4], A[5], A[6], A[7] parts), and the indices of each part may be distinguished by an offset of 2 (i.e., for i=0,1 and i=4,5, A[i] and A[i+2]). At a third stage, the coefficients may be distinguished by an offset of 1.

To provide an input with an appropriate offset and order to a butterfly unit, the first NTT unit 810-1 may couple each butterfly unit with a memory (e.g., a first-in-first-out (FIFO) memory) and a multiplexer.

Assuming, for example, that an 8-point NTT operation is performed, the first stage may be coupled with a memory of depth 4 because the coefficient indices of the butterfly operation are distinguished by an offset of 4. At the first stage, the first NTT unit 810-1 may fetch and store the first four input coefficients in a memory one by one in the first four cycles. Here, during the first four cycles, the first multiplexer 840 may select an input coming from the left based on a control signal (sel1=0).

Then, at the first stage, the remaining four input coefficients may be fetched one by one and sent to the BU 820, and the first four coefficients may be read one by one from their own FIFO memory and sent to the BU 820.

In this way, the BU 820 may receive coefficient pairs in the correct order during the four cycles. In other words, the BU 820 may receive A[0] of FIFO and A[4] of an input in the first cycle, receive A[1] and A[5] in the second cycle, receive A[2] and A[6] in the third cycle, and receive A[3] and A[7] in the fourth cycle. During the four cycles, the second multiplexer 850 may select a non-zero input based on a control signal (sel2=1).

At the first stage, a first output (e.g., A[0] to A[3]) of the BU 820 may be transmitted to the next stage, and a second output (e.g., A[4] to A[7]) may be stored in the FIFO for later transmission to the next stage. In this case, the first multiplexer 840 may select the input from the output of the BU 820 based on a control signal (sel1=1).

Finally, the first NTT unit 810-1 may be required to transmit coefficients (e.g., A[4] to A[7]) stored in the FIFO again to the first NTT unit 810-2 corresponding to the next stage. To this end, the coefficients may be read from the FIFO and transmitted to the BU 820, and the second multiplexer 850 may select 0 based on a control signal (sel2=0). Since the second input of the BU 820 is 0, the first input may be directly transmitted to the output and then transmitted to the first NTT unit 810-2 corresponding to the next stage (i.e., A[4]+0=A[4]).

The register 830 may be used to synchronize the output of the BU 820. The BU 820 may receive three inputs a, b, and w and perform the operations of a+b and (a−b)*w. A multiplication operation is added to the (a−b)*w operation, so the (a−b)*w operation may take longer than the a+b operation. Accordingly, the first NTT unit 810-1 may include the register 830 capable of storing the a+b operation so that both outputs may be output from the BU 820 at the same time. Because the multiplication operation may take several cycles, multiple registers 830 (e.g., three) may be provided.

FIG. 9 illustrates an example of an operation of a second NTT architecture, according to one or more embodiments.

As described above, an N-point NTT operation may include log₂N stages, where an N/2 butterfly operation is performed at each of the stages. Therefore, an N-point NTT may require a total of log₂N*(N/2) butterfly operations (as used herein “require” refers to a possible design parameter and is not to be interpreted as a per se requirement for all embodiments and examples described herein).

The second NTT architecture may instantiate every stage and all BUs at every stage. The second NTT architecture may use a total of log₂N*(N/2) BUs and connect these BUs to one another to implement the N-point NTT. The second NTT architecture may take all input coefficients (i.e., N coefficients) in one cycle and generate all output coefficients in one cycle.

Referring to FIG. 9, a second NTT architecture for N=8 is shown as an example. ω denotes a twiddle factor (an 8th identity root) of an 8-point NTT. The second NTT architecture may include 12 second NTT units. A second NTT unit may include a register placed after addition and subtraction operations. The register may be placed to synchronize an output of a BU. In FIG. 9, the numbers of inputs and outputs may respectively denote the coefficient indices of input and output polynomials.

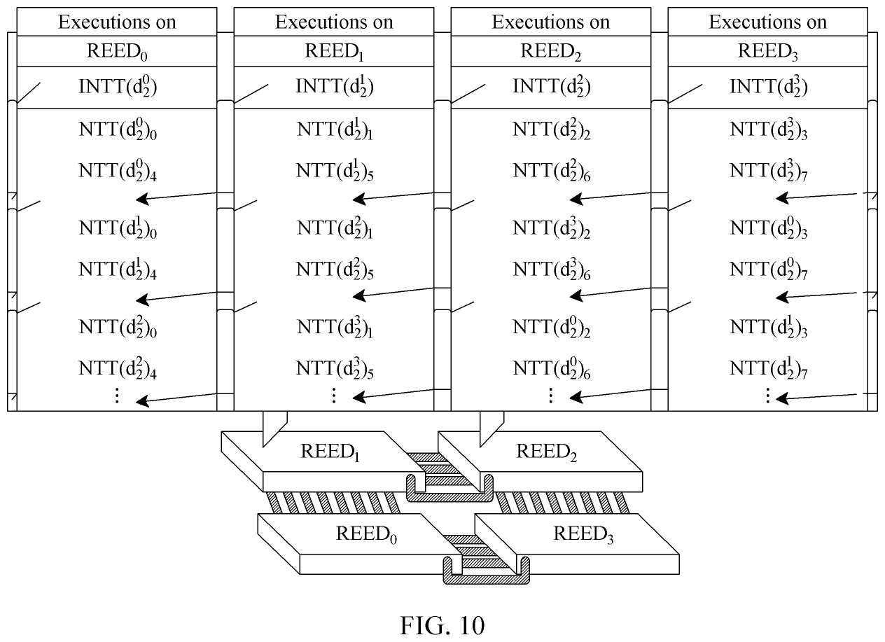

FIG. 10 illustrates an example of a data exchange method among chiplets, according to one or more embodiments.

A well-configured multi-chiplet design may (depending on implementation) ensure that various chiplets operate on unique data with as much independence as possible, minimizing interdependency. This is because data duplication is reduced and a shared memory is not generally used.

In a data distribution method, data (e.g., a key and a ciphertext) may be distributed across an RNS base. It should be noted that this RNS base of data is not to be grouped in order (chiplet; ηᵢ₊ⱼ∀0 [symbol] i<r and 0≤j<(L+K)/r) but rather should be interleaved (chipletᵢ ηⱼ₊ᵢ). This is because when a multiplicative depth starts to decrease, a qi RNS base is also removed sequentially. When sequences are not alternated, a core chiplet may quickly become idle, losing the benefit of parallel processing. Interleaving data distribution may ensure that all chiplets are fully utilized eventually. Therefore, these chiplets may not require data duplication and may be executed in parallel.

No matter how data is distributed, direct chiplet-to-chiplet communication should be provided. Distribution between RNS bases may alleviate this issue but may not fully eliminate it. A data exchange method (communication method) among core/PU chiplets according to some examples may be easily expanded to a higher configuration without causing a decrease in clock frequency (due to the efficient pipelining). Avoiding a communication bottleneck may be beneficial as communication throughput may partly determine how efficiently multiple chiplets may be arranged in a disaggregated state of charge (SoC) configuration.

Before proposing a solution, the reason for exchanging data between chiplets is described. Data exchange may be required for a modulus switch operation of a relinearization operation. This implies that each chiplet may have to transmit 2(r−1) L/r residue polynomials to another chiplet. In order to exchange a large amount of data, star-like communication between chiplets might be required to enable all chiplets may communicate with all other chiplets. With a star-like communication topology, an increase in an r value may result in complex and expensive communication. That is to say, star-like configurations may not scale well.

A data exchange method according to one or more embodiments may transfer an INTT result to a chiplet so that the INTT result is within the same chiplet. The data exchange method may use a long communication window between multiple chiplets.

A communication window is a time slot used to transmit data from one chiplet to the next in a chiplet system. A communication window may be a predetermined time window that allows optimized data transmission. The number of communication windows may be determined by the number of RNS-limbs in an FHE system and the number of chiplets used in a system.

For example, when it is assumed that a system has four chiplets from REED₀ to REED₃, each chiplet may start with an assigned RNS-limb, compute an INTT, and then perform an NTT. A chiplet may start transmitting and receiving an INTT result during a communication window while performing an NTT. For example, REED₀ may transmit an INTT result to REED₃ and receive an INTT result from REED₁. This may enable one-way ring-based communication. The non-limiting example described above is a ring that includes four chiplets.

For every (L+1)/r NTT, only one INTT result needs to be broadcasted, where L+1 may be the number of RNS limbs and r may be the number of REED chiplets. For a given chiplet-to-chiplet or REEDi+1-to-REEDi communication speed, the time required to transmit one INTT result to the next chiplet may be referred to as t_{comm}. The time it takes to calculate (L+1)/r NTT may be referred to as t_{comp}. A communication window duration may be min (t_{comm}, t_{comp}). Computation-communication parallelization efficiency may be achieved when t_{comm}≤t_{comp}. As the number of chiplets (r) increases, the window duration decreases. Therefore, in order to achieve computation-communication parallelism, it may be beneficial for the communication speed between chiplets to be faster.

Therefore, when inter-chiplet communication is not as fast as on-chip communication/computation, this long communication window may ensure that a chiplet does not run out of data. In conclusion, when the communication scheme is used, half of data may need to be transmitted and only one read/write port per chiplet may be required. In addition, by employing a communication window, it may be possible to overcome the possibility of slower chiplet-to-chiplet communication and reduce (or eliminate) the possibility of deadlock through non-blocking communication.

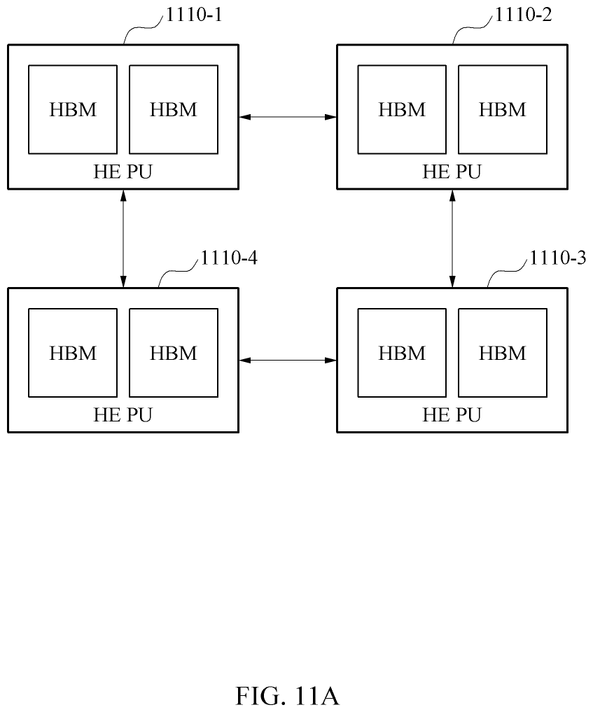

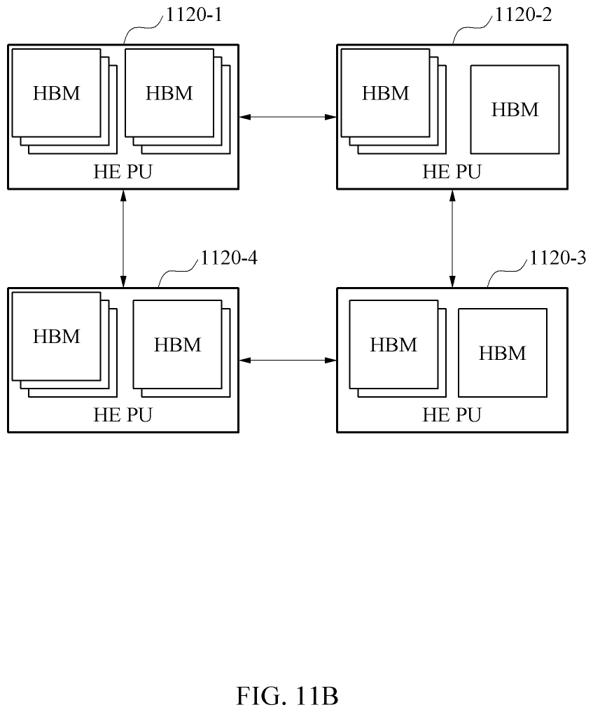

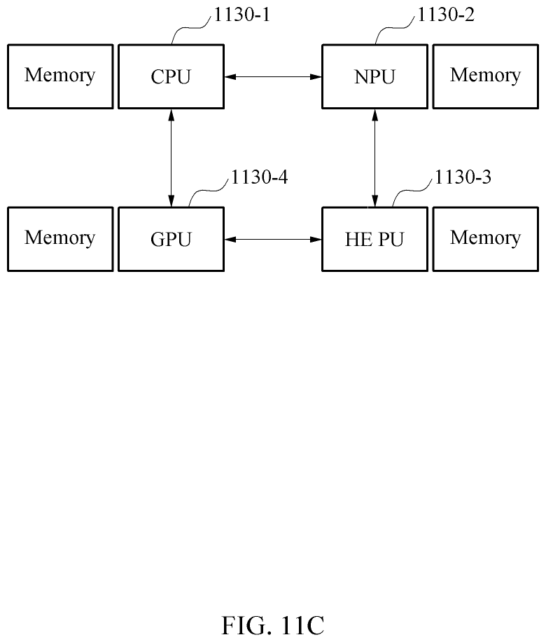

FIGS. 11A to 11C illustrate examples of a chiplet architecture, according to one or more embodiments.

Referring to FIG. 11A, four PUs 1110-1 to 1110-4 may be interconnected in a ring structure, as shown. Two memories (e.g., HBM and LPDDR) may be stacked on each PU.

Referring to FIG. 11B, four PUs (e.g., a first PU 1120-1, a second PU 1120-2, a third PU 1120-3, and a fourth PU 1120-4) may be interconnected in a ring structure. Memories of different numbers and structures may be stacked on the PUs. For example, two sets of memories may be stacked on the first PU 1120-1, and each set may include three stacked memories. Two sets of memories may be stacked on the second PU 1120-2, with the first set including three stacked memories and the second set including one memory. Two sets of memories may be stacked on the third PU 1120-3, with the first set including two stacked memories and the second set including one memory. Two sets of memories may be stacked on the fourth PU 1120-4, with the first set including three stacked memories and the second set including two memories.

Referring to FIG. 11C, heterogeneous core chiplets may be interconnected in a ring structure. For example, a CPU 1130-1, a neural PU (NPU) 1130-2, an HE PU 1130-3, and a GPU 1130-4 may be interconnected in a ring structure.

Although the description above uses mathematical notation, the mathematical notation/description is only an accurate and efficient description of hardware configuration and operations. The mathematical notation/description herein is sufficient to allow an engineer to design and construct hardware devices that have computational behavior that is consistent with the mathematical notation/description. In addition, it will be appreciated that most of the HE-related operations described herein are practically impossible for a human being to practice manually or mentally; the methods and apparatus described herein are only practically capable of realization through the use of physical circuitry.

The computing apparatuses, the chiplets, the electronic devices, the processors, the memories, the information output system and hardware, the storage devices, and other apparatuses, devices, units, modules, and components described herein with respect to FIGS. 1-11C are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11C that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An operation method performed by a computing device, the method comprising:
obtaining an input comprising a coefficient of a polynomial;
performing, by a preprocessing unit (PU), a preprocessing operation on the coefficient;
performing, by a first number-theoretic transform (NTT) architecture, a first NTT operation on a first element of the input for which the preprocessing operation is completed;
performing a Hadamard product operation between a result of the first NTT operation and a twiddle factor; and
based on a second NTT architecture, performing a second NTT operation on a second element of the input matrix for which the Hadamard product operation is completed.

2. The operation method of claim 1, wherein
the first NTT architecture comprises a first NTT unit corresponding to a stage comprised in the first NTT operation, and
first NTT units comprised in the first NTT architecture are operated independently of each other.

3. The operation method of claim 2, wherein each of the first NTT units comprises a butterfly operation unit (BU), a register, a first multiplexer, and a second multiplexer.

4. The operation method of claim 1, wherein
the performing of the preprocessing operation comprises multiplying the coefficient by a 2N-th root of unity, and
the N is a size of the input.

5. The operation method of claim 1, wherein
the performing of the second NTT operation comprises log 2N*(N/2) second NTT units, and
the N is a size of the input.

6. The operation method of claim 1, wherein the PU comprises a modular multiplier.

7. The operation method of claim 1, wherein the performing of the Hadamard product operation comprises, based on a modular multiplier, performing the Hadamard product operation.

8. A non-transitory computer-readable storage medium storing instructions that, when executed by a processor, cause the processor to perform the operation method of claim 1.

9. The operation method of claim 1, wherein the input is a matrix, and wherein the first element is a column of the matrix.

10. The operation method of claim 9, wherein the second element is a row of the matrix.

11. An operation device comprising:
a preprocessing unit (PU) configured to perform a preprocessing operation on a coefficient of a polynomial, wherein an input matrix comprises coefficients of the polynomial;
a first number-theoretic transform (NTT) architecture configured to perform a first NTT operation on a column element of the input matrix for which the preprocessing operation is completed;
a Hadamard unit configured to perform a Hadamard product operation between a result of the first NTT operation and a twiddle factor; and
a second NTT architecture configured to perform a second NTT operation on a row element of the input matrix for which the Hadamard product operation is completed.

12. The operation device of claim 11, wherein
the first NTT architecture comprises a first NTT unit corresponding to a stage comprised in the first NTT operation, and
first NTT units comprised in the first NTT architecture are operated independently of each other.

13. The operation device of claim 12, wherein each of the first NTT units comprises:
a butterfly operation unit (BU);
a register;
a first multiplexer; and
a second multiplexer.

14. The operation device of claim 11, wherein
the PU is configured to perform an operation of multiplying the coefficient by a 2N-th root of unity, and
the N is a size of the input matrix.

15. The operation device of claim 11, wherein
the second NTT architecture comprises log 2N*(N/2) second NTT units, and
the N is a size of the input matrix.

16. The operation device of claim 11, wherein the PU comprises a modular multiplier.

17. The operation device of claim 11, wherein the Hadamard unit is configured to, based on a modular multiplier, perform the Hadamard product operation.

18. The operation device of claim 11, wherein
the second NTT architecture is configured to perform a first inverse NTT (INTT) operation on a row element of an INTT matrix,
the Hadamard unit is configured to perform an INTT Hadamard product operation between a result of the first INTT operation and the twiddle factor,
the first NTT architecture is configured to perform a second INTT operation on a column element of the INTT matrix for which the INTT Hadamard product operation is completed, and
a modular multiplier is configured to perform a postprocessing operation on a result of the second INTT operation.

19. The operation device of claim 11, further comprising PUs, including the PU, interconnected to form a ring topology, and wherein each PU is configured with a respective memory chiplet that is not connected to the other PUs.
